(19) United States
(12) Patent Application Publication
(10) Pub. No.: US 2006/0182028 A1
(43) Pub. Date: Aug. 17, 2006

(54) Web services transport bootstrapping

(75) Inventors: Shannon J. Chan, Bellevue, WA (US); Thomas W. Kuehnel, Seattle, WA (US); Dale A. Sather, Seattle, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/045,452

(22) Filed: Jan. 28, 2005

(51) Int. Cl. H04L 12/26; H04L 1/00

(52) U.S. Cl. 370/230

(57) ABSTRACT

A system and methods to facilitate provision of network-based services is provided. The system comprises a signaling module that uses a first communication protocol to send a trigger signal to a potential recipient of a network-based service. The trigger signal indicates to the potential recipient that the network-based service is available for the potential recipient to access via the network. The system also includes a service module that receives a request from the potential recipient via a second communication protocol to provide to the potential recipient the network-based service that the trigger signal indicated was available.

### TECHNICAL FIELD

The subject invention generally relates to the provision of network-based computing services and specifically to systems and methods to initiate or bootstrap network communications to access such services.

### BACKGROUND OF THE INVENTION

Computing devices, including personal computers, workstations, minicomputers, mainframes, and similar devices, peripherals such as printers and facsimile machines, as well as an increasing number of mobile computing devices such as personal data assistants, and cellular telephones, among others, are typically able to communicate with other computing devices using some type of network. A network usually includes both hardware and software components.

Network-connected components typically communicate using a common protocol. One of the most prevalent protocols is version four of the Internet Protocol (IPv4 or simply IP). Each communicating component typically has an associated IP address to which communications are routed. However, the IPv4 protocol is hampered by an address space that is relatively limited compared to the number of communicating devices that need addresses. Additionally, because IP addresses are public, there are associated security concerns.

Network Address Translation (NAT) and firewalls are two systems that were created to extend available address spaces and address security concerns. Although very useful, such devices also erect certain communication barriers between network-connected components. As a result, communicating devices often cannot locate other devices on the network without employing special services or components.

### SUMMARY OF THE INVENTION

The following presents a simplified summary in order to provide a basic understanding. This summary is not an extensive overview. It is not intended to identify key/critical elements of the invention or to delineate the scope of the invention. Its sole purpose is to present some concepts of the invention in a simplified form as a prelude to the more detailed description later presented. Additionally, section headings used herein are provided merely for convenience and should not be taken as limiting in any way.

One aspect of the invention disclosed herein provides systems and methods for facilitating the provision of network-based services (such as web services) by components acting as service providers to components that receive or subscribe to those services, called events. In accordance with this aspect, a provider creates and sends a trigger signal in the form of a data packet and sends that trigger signal to the subscriber using an unreliable communication protocol such as uniform datagram protocol (UDP). The information in the data packet indicates to a subscriber that a desired event occurred and the associated data can be fetched via a reliable communication protocol and the network location at which a request for the service can be sent.

In accordance with another aspect of the invention, trigger signals assist in the provision of a network-based service by facilitating the opening of communication channels through firewalls that additionally may act as network address translators (NATs) or port mappers or both. Such facilitation is accomplished by using a communication address, port number, and protocol that will be allowed to traverse the firewall to reach the subscriber. The subscriber can then request that the firewall open a communication channel for the subscriber to access the service.

Still another aspect of the invention involves the use of a proxy to facilitate communications between providers and subscribers. The proxy may always act as an intermediary between the provider and the subscriber or may simply act as a central registry or repository for providers so that subscribers may request that the proxy assist it in contacting a provider of the desired service. Conversely, the proxy can also assist the provider in finding subscribers to which it may provide its service. When acting as a central registry or repository, once a pairing between a provider and a subscriber is made, service communications flow between the provider and the subscriber without further involvement from the proxy.

The provision of any network service includes some security risk. That risk may be mitigated in accordance with various aspects of the invention by using techniques such as encryption or digital signatures. Use of these techniques can assist to authenticate the identities of providers and subscribers, to help ensure that the contents of network communications have not been altered during transmission between the communicating components, and to protect the contents from being observed by third parties. The use of at least one of these techniques can significantly raise the security level of network communications.

To the accomplishment of the foregoing and related ends, the invention, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed and the subject invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 is a system block diagram of a communication system in accordance with one aspect of the invention.

FIG. 2 is a schema diagram for a simple object access protocol (SOAP) object that may be used in accordance with various aspects of the invention.

FIG. 3 is a flow diagram depicting an operation in accordance with another aspect of the invention.

FIG. 4 is a system block diagram of a communication system in accordance with still another aspect of the invention.

FIG. 5 is a flow diagram depicting an operation in accordance with yet another aspect of the invention.

FIG. 6 is a system block diagram of a communication system in accordance with a further aspect of the invention.

FIG. 7 is a flow diagram depicting an operation in accordance with still yet another aspect of the invention.

FIG. 8 illustrates an exemplary networking environment, wherein novel aspects of the invention can be employed.

FIG. 9 illustrates an exemplary operating environment, wherein novel aspects of the invention can be employed.

### DETAILED DESCRIPTION OF THE INVENTION

The subject invention relates to systems and methods to facilitate the provision of network-based services, such as web services. As used in this application, terms “component,” “system,” and the like are intended to refer to a computer-related entity, either hardware, software (e.g., in execution), and/or firmware. For example, a component can be a process running on a processor, a processor, an object, an executable, a program, and/or a computer. For example, both an application running on a server and the server can be components. One or more components can reside within a process and a component can be localized on one computer and/or distributed between two or more computers.

The subject invention is described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention. Additionally, although specific examples set forth may use terminology that is consistent with client/server architectures or may even be examples of client/server implementations, skilled artisans will appreciate that the roles of client and server may be reversed, that the subject invention is not limited to client/server architectures and may be readily adapted for use in other architectures, specifically including peer-to-peer (P2P) architectures, without departing from the spirit or scope of the invention.

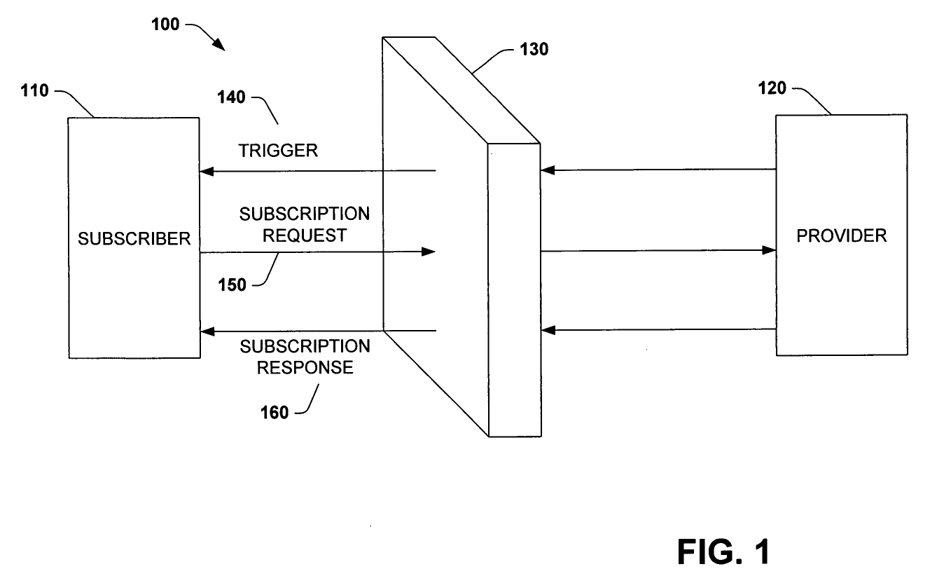

FIG. 1 illustrates a basic implementation of a communication system 100 in accordance with one aspect of the invention. The system 100 includes a subscriber 110. The subscriber 110 is a component that will be the recipient of a network-based service. For example, the subscriber 110 can be a newsreader that is configured to periodically gather fresh stories from a web server whenever a previously unpublished story is posted to the web server. In this example, the subscriber has previously registered itself with a provider 120 of a network-based service, such as by providing a unique identifier and a public IP address to which the service should be directed.

The subscriber 110 is located on a network behind a firewall 130. The firewall 130 is interposed between the subscriber 110 and the provider 120 and serves as a protective barrier between the subscriber 110 and other computing devices outside the firewall 130. The firewall 130 commonly serves to prevent unauthorized access to the network of the subscriber 110 by components not on that network. The firewall 130 also may prevent unauthorized access by the subscriber 110 (or other components on the network of the subscriber 110) to components outside the firewall 130. This prevention is usually accomplished by blocking data communications in one or both directions through the firewall 130.

Data communications usually occur via communication channels called ports. Each communicating component, in addition to having an IP address, has a group of numbered communication ports that may or may not be open and that may or may not have associated service components active. Certain ports are designated as well-known in that those ports are always used in connection with various network services. For example, web browsing communications using HTTP typically use port 80.

Firewalls, such as the firewall 130, pose certain problems for the provision of network-based services. Specifically, by blocking data communications, the firewall 130 makes it impossible for subscribers such as the subscriber 110 to access network-based services. Therefore, the firewall 130 can be configured to allow certain data communications to pass through based upon such indicia as the port number to which the communication is directed or the type of protocol used by the data communication. Additionally, the firewall 130 may be configured to allow certain data communications to occur in only one direction or in both directions upon request from a trusted component, such as a component behind the firewall 130.

Firewalls, such as the firewall 130, may also provide network address translation (NAT) and port mapping services. In these instances, the firewall 130 can be configured to present a single (or possibly a group of) public IP address(es) to components outside the firewall. Components outside the firewall 130 usually cannot ascertain that there may be many components behind the firewall 130, all of which are sharing the same public IP address. Components within the firewall 130 each have at least one private IP address. The firewall 130 maintains a table that maps data communications between public and private IP addresses and adjusts source address information, comprising private source IP address and source port from inside the firewall to the corresponding public IP address and source port that is visible outside, in data packets accordingly.

Certain network-based services may operate using a “pull” paradigm. An example of this is web browsing. The web browser initiates a request for content from a web server using the GET method of the HTTP protocol. The server then sends an HTTP Response to the requestor. In this manner the browser “pulls” the content from the web server. Other services may operate on a “push” paradigm. In that system, when the service provider determines that it has to provide the service, it initiates connections with all components that are to receive the service and provides the service. In that manner, data is “pushed” to the service recipients.

Both the pure push and pull paradigms have drawbacks. Notable drawbacks of the pull paradigm include possibly excessive lag times between the time a service is available and the time it is accessed. In a push paradigm, the service provider may never know that its data communication was blocked by a firewall and therefore the subscriber never received the service. These drawbacks can result in troublesome situations if the service is something like a component notifying another component that it needs human attention, such as a laser printer running out of toner or a facsimile machine running out of paper.

One aspect of the invention uses a combination of certain features of the push and pull paradigms. Returning again to the example in FIG. 1, when the provider 120 determines that it has new content to deliver to subscribers, it uses an unreliable protocol to send a trigger signal 140 to the subscriber 110 at a previously-provided public IP address and available port number for the subscriber 110. The trigger signal 140 can be, for example, a UDP packet including a simple object access protocol (SOAP) packet that contains a location indicator of an available web service. The firewall 130 receives the trigger signal 140, performs any necessary NAT and port mapping, and forwards the trigger signal 140 to the subscriber 110. The firewall/NAT is configured to let the UDP packet traverse based on static or dynamic configuration. The latter is accomplished by a previously-sent UDP packet from within the firewall and is a common feature of many firewall/NAT implementations. The UDP packet establishes a mapping and triggers the opening of the firewall/NAT for a certain period of time, typically in the range of tens of seconds. The provider 120 begins a time-out countdown for a set duration (such as 30 seconds). If the timeout countdown expires without the provider 120 having at least begun to provide the service to the subscriber 110, the provider 120 assumes that the trigger signal did not reach the subscriber 110 and will send another trigger packet.

Upon receiving the trigger signal 140, the subscriber 110 will initiate a service request 150 using a reliable protocol. In this example, the service request is an HTTP GET request via TCP. The service request 150, because it originates from behind the firewall 130, will usually cause the firewall 130 to allow data communications originating outside the firewall 130 to pass through to the subscriber 110. When the provider 120 receives the service request 150, it will send a service response 160 to the subscriber 110.

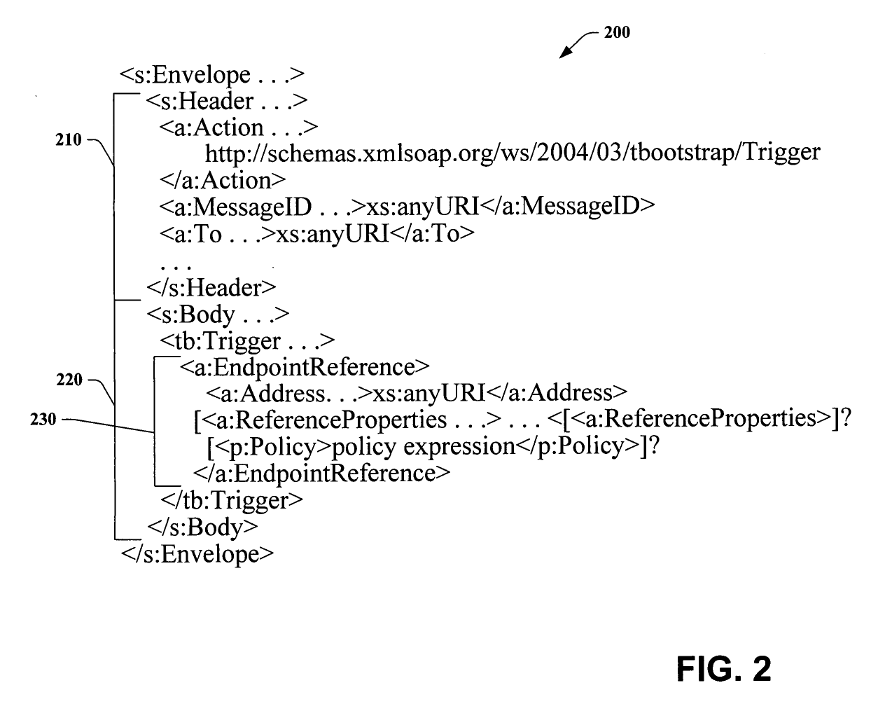

Turning to FIG. 2, an exemplary schema for a SOAP packet 200 that may be used in conjunction with the trigger signal 140 is shown. The SOAP packet 200 is addressed to the subscriber 110 as described above and includes a header 210 and a body 220. Within the body 220 is an endpoint reference 230 that is a uniform resource indicator (URI) of a location of the service to be provided. The subscriber 110 can use the endpoint reference to determine to where it should direct the service request 150.

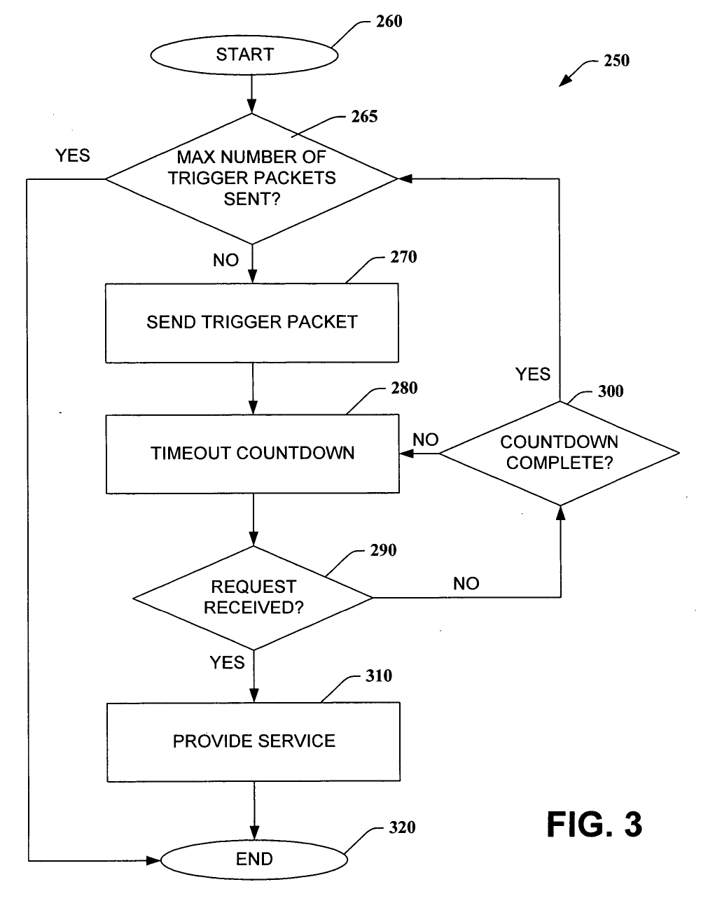

Referring to FIG. 3, a methodology in accordance with one or more aspects of the subject invention is illustrated. While, for purposes of simplicity of explanation, the methodology of FIG. 3 and other figures presented is shown and described as a series of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that the methodology could alternatively be represented as a series of interrelated states or events, such as in a state diagram. Moreover, not all illustrated acts may be required to implement the methodology in accordance with the subject invention.

FIG. 3 is a flow diagram depicting a network-based service communication method 250 in accordance with an aspect of the invention. Processing begins at START block 260 and proceeds to decision block 265 where a determination is made whether a maximum number of trigger packets have been sent. If that determination is positive, processing is terminated at END block 320. If negative, processing continues to process block 270 where a trigger packet is generated and sent to a subscriber of a network-based service. Processing continues at process block 280 where a timeout countdown is conducted. At decision block 290, a determination is made regarding whether a request for the service associated with the trigger packet has been received. If no, processing continues at decision block 300 where a determination is made regarding whether the timeout countdown has concluded. If no, processing continues at process block 280 where the timeout countdown continues. If yes, processing continues at process block 270 where a new trigger packet is created and sent. If the determination at decision block 290 indicates that a request for the service was received, processing will continue at process block 310. At process block 310, the requested service is provided. Processing then concludes at END block 320.

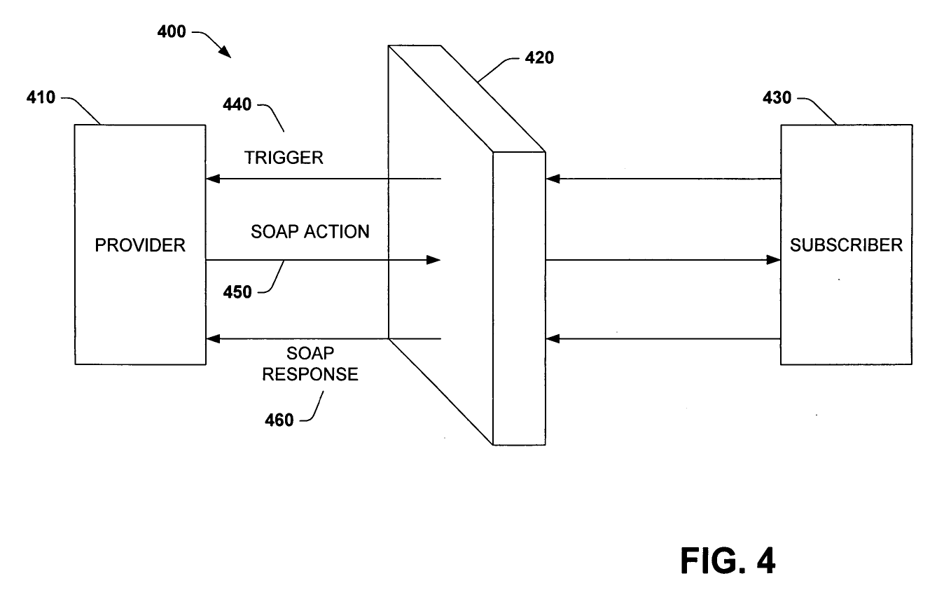

FIG. 4 depicts a system 400 in accordance with another aspect of the invention. In that system 400, a provider 410 is protected by a firewall 420 and provides network-based services to a subscriber 430. The subscriber 430 sends a trigger packet 440 to the provider 410 to indicate that a network-based service desired from the provider 410. The trigger packet 440 originating from behind the firewall 420 is allowed to pass through in accordance with the configuration of the firewall 420. The firewall 420 will perform any NAT and port mapping applicable before forwarding the trigger packet 440 to the provider 410. Subsequently, the provider 410 sets up a reliable transport channel, such as HTTP over TCP, over which a SOAP action 450 from the subscriber is conveyed. The SOAP response 460 is conveyed in the reverse direction.

The trigger packet 440 may be implemented as SOAP over UDP using the schema presented in FIG. 2 or an alternate suitable schema. In such case, an endpoint reference included in the SOAP packet may be either in the form of a public reference that directly refers to the provider 410 and that the subscriber 430 may use from outside the firewall 420. Alternately, the endpoint reference may be a reference known to the firewall 420 that is mapped to a private IP address. In that case, the firewall 420 will make the appropriate adjustments if performing NAT or port mapping.

As a result of any NAT or port mapping (or simply as the product of UDP packet generation), the subscriber 430 can learn the public IP address and port of the provider 410. As in a previous example, the service request 450 may be an HTTP GET request over TCP. Also, both here and in the previous example, HTTP POST may be used if appropriate. As the connection is created from within the firewall/NAT, the service request is able to traverse the firewall.

In prior examples, an initiating communication such as a trigger packet used a first communication protocol that was unreliable, such as UDP. Service communications used a second protocol that was reliable, such as TCP. It should be appreciated that in this and other examples throughout this disclosure, the first and second protocols can be the same protocol, can be reliable or unreliable, can be a ubiquitous protocol like HTTP, FTP, SMTP, TCP, UDP, IP, or can be a private or proprietary protocol that may or may not have been designed specifically for the service provided. For example, when the provided service is the streaming of video and/or audio information, it is usually preferred that the trigger packet and the service packets both use an unreliable protocol such as UDP. In any event, communicating components should be configured to expect certain types of communications and to deal with those communications appropriately.

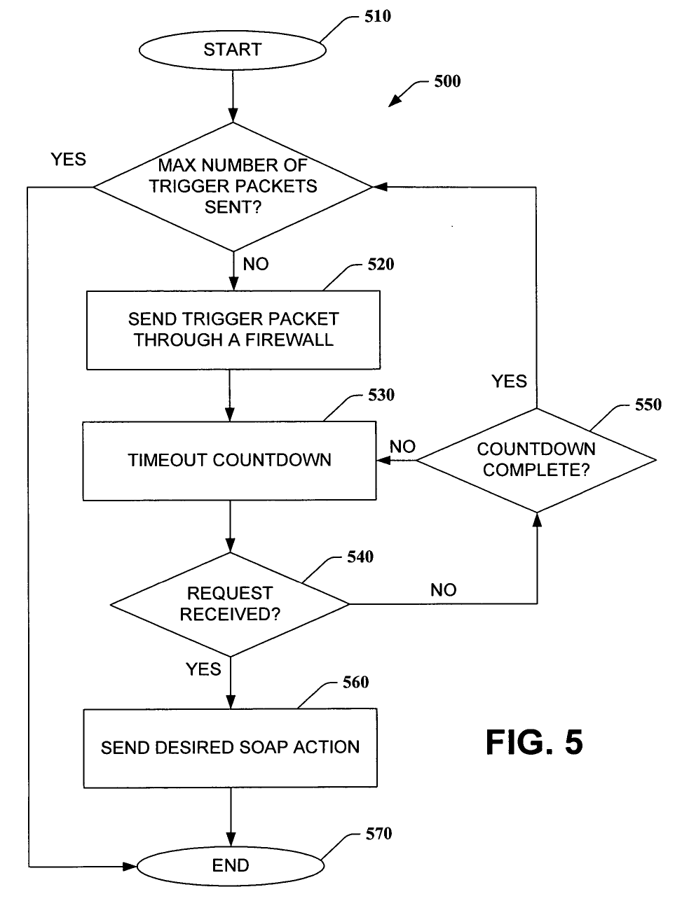

FIG. 5 is a flow diagram depicting a network-based service communication method 500 in accordance with another aspect of the invention. Processing begins at START block 510 and proceeds to decision block 515 where a determination is made whether a maximum number of trigger packets have been sent. If that determination is positive, processing is terminated at END block 570. If negative, processing continues to process block 520 where a subscriber such as the subscriber 430 generates a trigger packet and sends the packet via a first communications protocol to a provider of a network-based service such as the provider 410. Processing continues at process block 530 where a timeout countdown is conducted by the subscriber. At decision block 540, a determination is made regarding whether a request for establishing a communication channel associated with the trigger packet has been received by the subscriber via a second communications protocol. If no, processing continues at decision block 550 where a determination is made whether the subscriber has concluded its timeout countdown. If the timeout countdown has not been completed, processing continues at process block 530 where the timeout countdown continues. If the timeout countdown is complete, processing continues at decision block 515. If the determination at decision block 540 indicates that a request for the service was received, processing will continue at process block 560. At process block 560, the SOAP action is sent to the provider. Processing then concludes at END block 570.

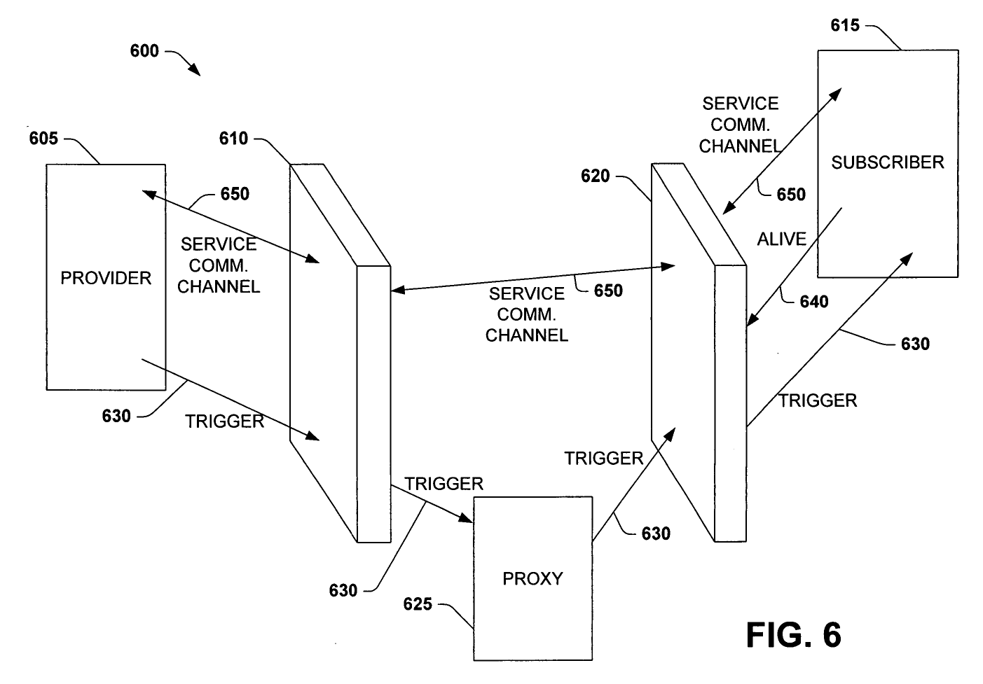

FIG. 6 depicts a system 600 in accordance with yet another aspect of the invention. The system 600 includes a provider 605 of a network-enabled service that is behind a first firewall 610. A subscriber 615 to the network-enabled service is behind a second firewall 620. A proxy 625 is outside both firewalls and is interposed between the provider 605 and the subscriber 615.

The proxy 625 may be a component that acts as a central registry for both providers and subscribers to match subscribers that desire to receive services with providers of those services. Additionally or alternately, the proxy 625 may be more akin to a traditional proxy server such as a web proxy server of the type commonly in use in some corporate networks to provide an insulating layer between components of the corporate network and components on other networks or the Internet.

When the provider 605 determines that it has a service to provide to a subscriber, the provider 605 creates and sends a trigger packet 630 to the subscriber via an unreliable protocol. The first firewall 610 receives the packet and performs NAT and port mapping services before forwarding the trigger packet 630 to the proxy 625. The proxy 625 then maps the originating provider to the intended subscriber and forwards the trigger packet 630 to the subscriber 615 by replacing the packet's destination IP address with the address found during the mapping. The proxy may also modify the content of the trigger packet so that it indicates the public IP address of other endpoint indicator of the provider 605 if the provider 605 did not provide that information itself. The second firewall 620 then intercepts the trigger packet 630, performs NAT and port mapping services, and forwards the trigger packet 630 to the subscriber 615.

In this example, a communication channel through the second firewall 620 was previously opened by the subscriber 615 when the subscriber 615 sent an activity or “alive” packet to the second firewall 640. The alive packet 640 may be implemented as a SOAP packet over UDP or simply as a UDP packet. Upon receiving the alive packet 640, the second firewall 620 will open a communication channel for a limited time, for example, for 30 to 60 seconds. The subscriber 615 can periodically send alive packets to the firewall 620 to open new channels or to keep previously opened channels from closing.

Upon receipt of the trigger packet 630, the subscriber 615 will request and receive network-based services via service communications 650 via a reliable protocol. Service communications 650 will occur between the provider 605 and the subscriber 615 and additionally will traverse both firewalls, but will not further use the proxy 625. However, service communications 650 may be routed through the proxy 625 if desired for various reasons that may be service- or implementation-dependent.

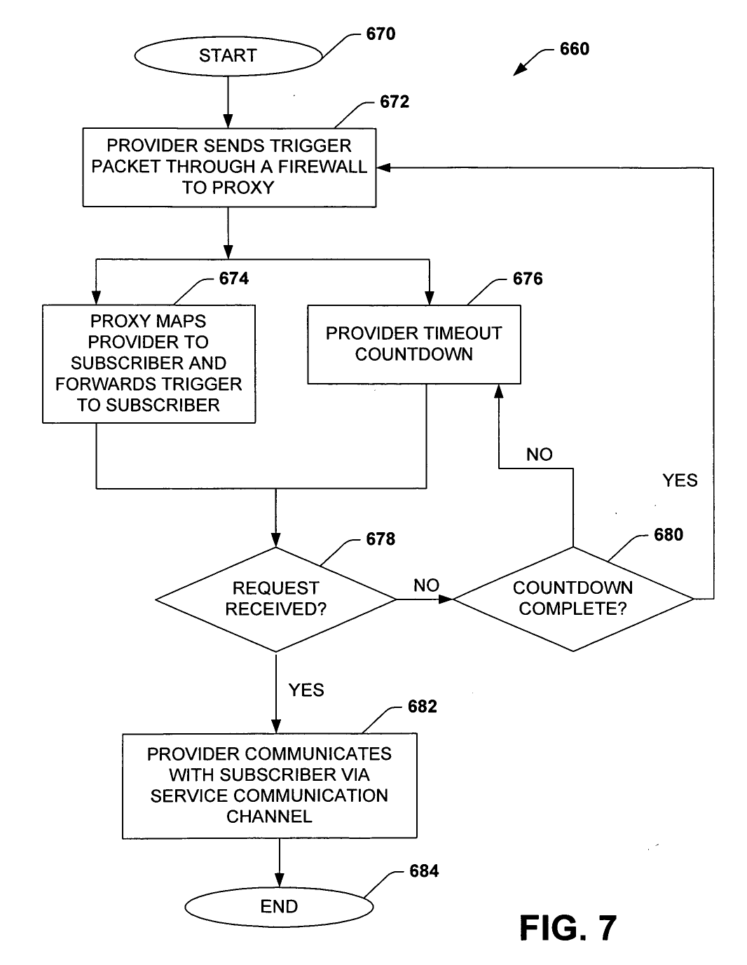

FIG. 7 is a flow diagram depicting a method 660 in accordance with still another aspect of the invention. The method 660 begins at START block 670 and continues at process block 672 where the provider sends a trigger signal including service or location data to a subscriber through a firewall and via a proxy using an unreliable protocol. At process block 674 the proxy maps the provider to the subscriber using information in the trigger packet and forwards the trigger packet to the subscriber. Process block 676 may be executed concurrently with process block 674 and initiates a timeout countdown sequence. At decision block 678 a determination is made whether the provider has received a service request in response to the trigger packet sent at process block 672. If no such request has been received, processing continues at decision block 680 where a determination is made whether the timeout countdown has completed. If no, processing continues at process block 676 where the timeout countdown continues. If yes, processing continues at process block 672 where another trigger packet is created and sent. If a yes determination was made at decision block 678, processing continues at process block 682 where the provider communicates with the subscriber via a service communication channel. Processing then terminates at END block 684.

It will be appreciated by those of ordinary skill in the art that there is some amount of risk to the security of a computer system in any network communication activity. To attempt to mitigate this security risk, various measures may be employed with the systems and methods described above. Prevalent among available mitigation measures are those involving authentication schemes, data encryption (potentially using public, private, symmetric, or asymmetric keys, or other approaches such as quantum cryptography), or digital signatures. One possible approach is to use digital certificates from a trusted authority to sign trigger packets. That approach may be used as an alternative or addition to encrypting the portion of the trigger packet that identifies the location of the available service so that only the intended recipient of the trigger packet may readily access the contents of the trigger packet. The use of any one or combination of more than one of these techniques in this context is generally referred to as signing.

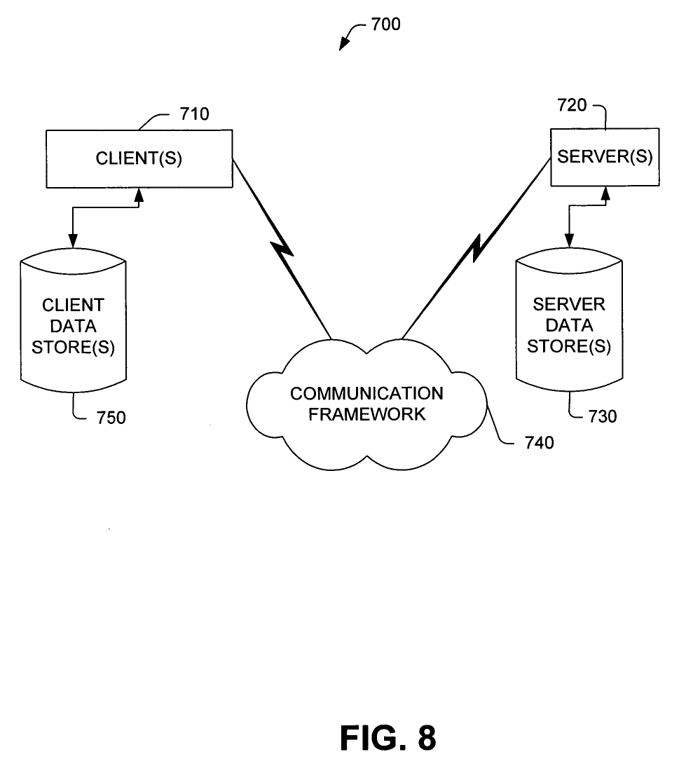

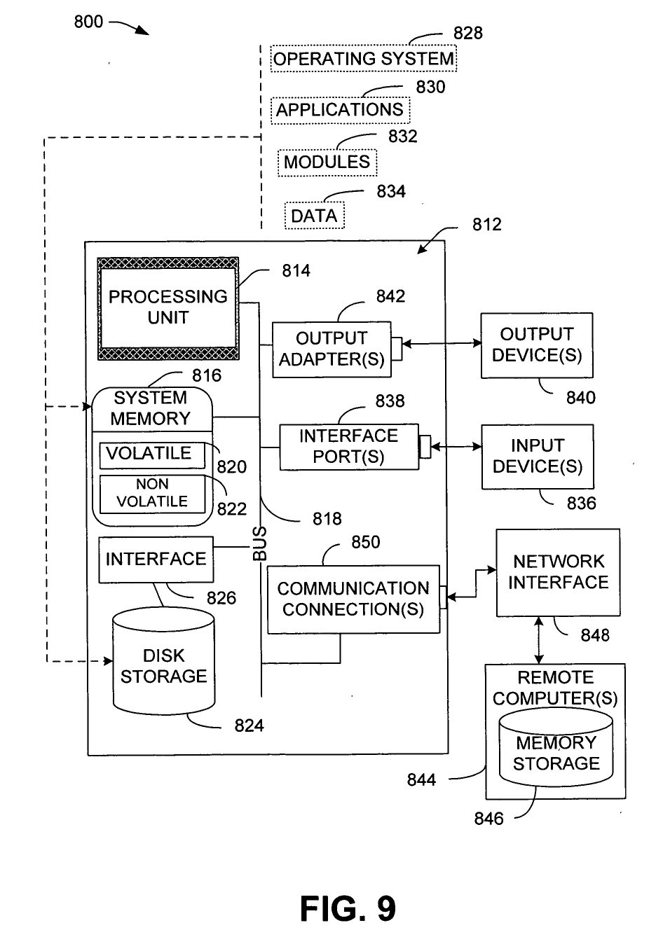

In order to provide additional context for implementing various aspects of the subject invention, FIGS. 8-9 and the following discussion is intended to provide a brief, general description of a suitable computing environment within which various aspects of the subject invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

FIG. 8 is a schematic block diagram of a sample-computing environment 700 with which the subject invention can interact. The system 700 includes one or more client(s) 710. The client(s) 710 can be hardware and/or software (e.g., threads, processes, computing devices). The system 700 also includes one or more server(s) 720. The server(s) 720 can be hardware and/or software (e.g., threads, processes, computing devices). The servers 720 can house threads or processes to perform transformations by employing the subject invention, for example.

One possible means of communication between a client 710 and a server 720 can be in the form of a data packet adapted to be transmitted between two or more computer processes. The system 700 includes a communication framework 740 that can be employed to facilitate communications between the client(s) 710 and the server(s) 720. The client(s) 710 are operably connected to one or more client data store(s) 750 that can be employed to store information local to the client(s) 710. Similarly, the server(s) 720 are operably connected to one or more server data store(s) 730 that can be employed to store information local to the servers 740.

With reference to FIG. 9, an exemplary environment 800 for implementing various aspects of the invention includes a computer 812. The computer 812 includes a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814.

The system bus 818 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 816 includes volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable ROM (EEPROM), or flash memory. Volatile memory 820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 812 also includes removable/non-removable, volatile/non-volatile computer storage media. For example, FIG. 9 illustrates a disk storage 824. The disk storage 824 includes, but is not limited to, devices like a magnetic disk drive, floppy disk drive, tape drive, Jaz drive, Zip drive, LS-100 drive, flash memory card, or memory stick. In addition, disk storage 824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to the system bus 818, a removable or non-removable interface is typically used such as interface 826.

It is to be appreciated that FIG. 9 describes software that acts as an intermediary between users and the basic computer resources described in the suitable operating environment 800. Such software includes an operating system 828. The operating system 828, which can be stored on the disk storage 824, acts to control and allocate resources of the computer system 812. System applications 830 take advantage of the management of resources by operating system 828 through program modules 832 and program data 834 stored either in system memory 816 or on disk storage 824. It is to be appreciated that the subject invention can be implemented with various operating systems or combinations of operating systems.

A user enters commands or information into the computer 812 through input device(s) 836. The input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port may be used to provide input to computer 812, and to output information from computer 812 to an output device 840. Output adapter 842 is provided to illustrate that there are some output devices 840 like monitors, speakers, and printers, among other output devices 840, which require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a personal computer, a server, a router, a network PC, a workstation, a microprocessor based appliance, a peer device or other common network node and the like, and typically includes many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 850 refers to the hardware/software employed to connect the network interface 848 to the bus 818. While communication connection 850 is shown for illustrative clarity inside computer 812, it can also be external to computer 812. The hardware/software necessary for connection to the network interface 848 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system to facilitate provision of network-based services, comprising:
a signaling module that uses a first communication protocol to send a trigger signal to a potential recipient of a network-based service, the trigger signal indicating to the potential recipient that the network-based service is available for the potential recipient; and
a service module that receives a request from the potential recipient via a second communication protocol to provide to the potential recipient the network-based service that the trigger signal indicated was available.

2. The system of claim 1, wherein the first communication protocol is different from the second communication protocol.

3. The system of claim 2, wherein the first communication protocol is an unreliable protocol.

4. The system of claim 2, wherein the second communication protocol is a reliable protocol.

5. The system of claim 1, wherein the trigger signal includes at least one of an indication of a location of the network-based service or a uniform resource identifier.

6. The system of claim 5, wherein the trigger signal is signed.

7. A data structure including the system of claim 5, embodied in a form selected from:
a computer-readable medium; and
a data signal, wherein data of the data structure includes at least one element that is signed.

8. A method for facilitating network communications comprising:
sending a trigger signal from a network service provider using a first communication protocol that indicates to a subscriber of a network service that the network service is available for the subscriber via a second communication protocol.

9. The method of claim 8, further comprising:
receiving a signal from the subscriber that includes a request to access the network service via the second protocol.

10. The method of claim 9, wherein the first communication protocol is at least substantially the same as the second communication protocol.

11. The method of claim 9, wherein at least one of either the first communication protocol or the second communication protocol is an unreliable protocol.

12. The method of claim 9, wherein at least one of either the first communication protocol or the second communication protocol is a reliable protocol.

13. The method of claim 9, wherein the trigger signal includes at least one of an indication of a location of the network service and a uniform resource identifier.

14. Computer-interpretable instructions capable of causing a computing device to perform the method of claim 9, embodied in a form selected from:
a computer-readable medium; and
a data signal, wherein said instructions include at least one instruction that is signed.

15. A system to facilitate provision of network-based services, comprising:
means for sending a trigger signal to a subscriber of a network-based service using a first communication protocol that indicates that a network service is available to the subscriber via a second communication protocol; and
means for receiving a signal from the subscriber that includes a request to access the network service via the second protocol.

16. The system of claim 15, wherein the first communication protocol is at least substantially the same as the second communication protocol.

17. The system of claim 15, wherein at least one of either the first communication protocol or the second communication protocol is an unreliable protocol.

18. The system of claim 15, wherein at least one of either the first communication protocol or the second communication protocol is a reliable protocol.

19. The system of claim 15, wherein the trigger signal includes at least one of an indication of a location of the network service and a uniform resource identifier.

20. A data structure including the system of claim 19, embodied in a form selected from:
a computer-readable medium; and
a data signal, wherein data of the data structure includes at least one element that is signed.
